(19) United States
(12) Patent Application Publication
(10) Pub. No.: US 2015/0309913 A1
(43) Pub. Date: Oct. 29, 2015

(54) IDENTIFYING POTENTIALLY UNINITIALIZED SOURCE CODE VARIABLES

(71) Applicant: International Business Machines Corporation, Armonk, NY (US)

(72) Inventors: Cary L. Bates, Rochester, MN (US); Lee N. Helgeson, Rochester, MN (US); Justin K. King, Rochester, MN (US); Michelle A. Schlicht, Rochester, MN (US)

(73) Assignee: International Business Machines Corporation, Armonk, NY (US)

(21) Appl. No.: 14/260,628

(22) Filed: Apr. 24, 2014

(51) Int. Cl. G06F 11/36

(52) U.S. Cl. CPC G06F 11/3624

(57) ABSTRACT

Computer program source code is represented by nodes in a control flow graph. A set of target nodes is identified, where each node in the set of target nodes includes at least one line of source code that defines a modification to a particular variable used in the computer program. A usage score relating to the variable is calculated for each target node. Each usage score is then recalculated based on the earlier scores and also based on the modifications to the variable that are defined by the lines of source code. Each recalculated score is compared to its corresponding earlier score, and if any score has changed, then the process repeats. Scores are recalculated based on the most recently calculated scores until the scores stop changing. The final scores may then be displayed.

### BACKGROUND

The present disclosure relates to computer program source code analysis, and more specifically relates to evaluating the likelihood that a source code variable is uninitialized in a section of source code.

In computer program source code, an uninitialized variable is a variable that is declared but is not set to a definite known value before it is used. During program execution, an uninitialized variable will have an unpredictable value. Uninitialized variables are programming errors and are a common source of software failures.

### SUMMARY

Disclosed herein are embodiments of a method, computer program product, and system for evaluating usage of a variable in computer program source code. The computer program source code is represented by a plurality of nodes in a control flow graph. A processor identifies a set of target nodes in the control flow graph. Each target node includes at least one target line of source code. Each target line of source code defines a modification to the variable.

The processor generates a set of scores corresponding to the set of target nodes. The processor then generates a set of new scores corresponding to the set of target nodes. The set of new scores is based on the modifications to the variable defined by the target lines, and is further based on the set of earlier scores. In some embodiments, each score in the set of new scores is based on an average predecessor score calculated from a subset of the earlier scores.

The two sets of scores are compared, and until each new score is unchanged from its corresponding earlier score, the set of earlier scores is replaced by the set of new scores and the processor generates another set of new scores. In some embodiments, the scores are then displayed.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example method for generating a variable initialization scorecard for computer program source code.

FIG. 2 depicts an example method for determining an input score for a source code variable entering a node in a control flow graph.

FIG. 3 depicts an example method for determining an output score for a source code variable exiting a node in a control flow graph.

FIG. 4 depicts a high-level block diagram of an example system for implementing one or more embodiments of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer program source code analysis, and more particular aspects relate to evaluating the likelihood that a source code variable is uninitialized in a section of source code. While the present disclosure is not necessarily limited to such applications, various aspects of the disclosure may be appreciated through a discussion of various examples using this context.

Uninitialized variables in computer program source code are common sources of bugs encountered during software development. An uninitialized variable is a variable that is declared but is not set to a definite known value before it is used. During program execution, an uninitialized variable will have an unpredictable value. When uninitialized variables are then referenced in subsequent lines of source code, they propagate this unpredictability to other variables. For example, in the source code line var3=var1+var2, if var1 or var2 is uninitialized, then the value of var3 will also be unpredictable, even if var3 were validly initialized earlier in the program.

Uninitialized variables can be particularly frustrating to debug because on one run the program may function correctly while on another run the program may not function correctly. Although there are tools available for detecting uninitialized variables, these tools may be of limited use to a programmer when debugging code in large software projects with large numbers of uninitialized variables. This may be particularly true when such variables are declared in source code that is developed and managed by other programmers or other teams of programmers.

A variable initialization scorecard may enable programmers to examine source code variables and focus on those variables at greatest risk of being uninitialized. Such a scorecard may provide a numerical score for each variable at each line of source code. A variable's score may be based on how the variable is used and modified in the source code, and may be affected by other variables' scores. A maximum score may indicate that the variable has been assigned a constant value at that point in the program and is therefore at no risk of being uninitialized, at least at that point in the program. A minimum score may indicate that the variable is declared but uninitialized at that point in the program and therefore corrective action should be taken. A score between the maximum and minimum may indicate the likelihood that the variable is uninitialized or affected by an uninitialized variable at that point in the program, with a lower score indicating a greater likelihood than a higher score. A user may then focus debug efforts on the earliest places in the source code where variables have the lowest scores.

The variables' scores may be determined by statically analyzing the source code using algorithms such as those described below. After the scorecard is generated, the scores may be presented to a user, such as a programmer or software developer, who may then use the scores to help determine where to focus his or her debug efforts. The scorecard may allow the user to more easily see relationships among variables and more easily determine which variables need further investigation.

The scores may be presented to the user in a variety of ways during both static and runtime debugging. For example, review tools for performing static source code analysis may be configured to allow the user to hover the cursor over a variable to retrieve its score for that particular line of source code. The tools may be configured to highlight variables with scores below a configurable threshold. The tools may be configured to detect patterns and relationships among variable scores, and may therefore alert the user when fixing one variable may fix other variables. A runtime debugger may be configured to present and/or highlight the scores for one or more variables, for example when an exception is taken with an unknown root cause.

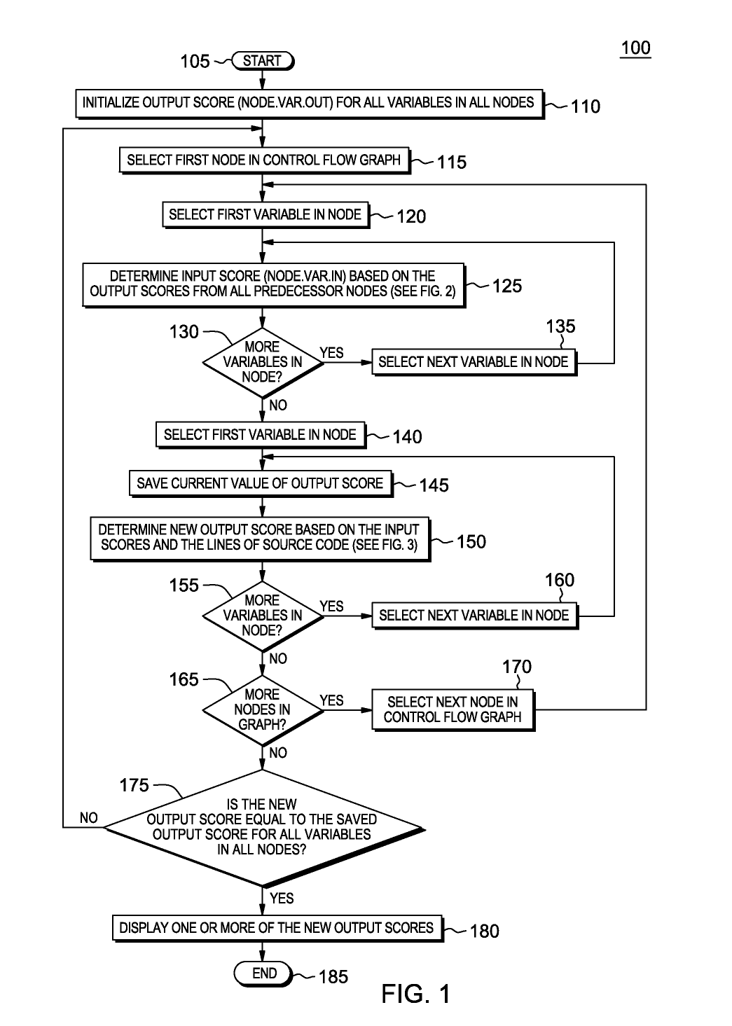

FIG. 1 depicts an example method 100 for generating a variable initialization scorecard for computer program source code. The computer program is represented by a control flow graph. In the control flow graph, each node represents a basic block of source code. A basic block of source code is a straight-line code segment without any jumps or jump targets. In a control flow graph, jump targets start a block and jumps end a block. Jumps in the control flow are represented by directed edges between nodes.

From start 105, an output score may be initialized for all variables in all nodes at 110. A variable's output score at a particular node (node.var.out) is the variable's score when it leaves that particular node. A variable's input score at a particular node (node.var.in) is the variable's score when it enters that particular node. In some embodiments, the output score for all nodes and all variables may be initialized to zero.

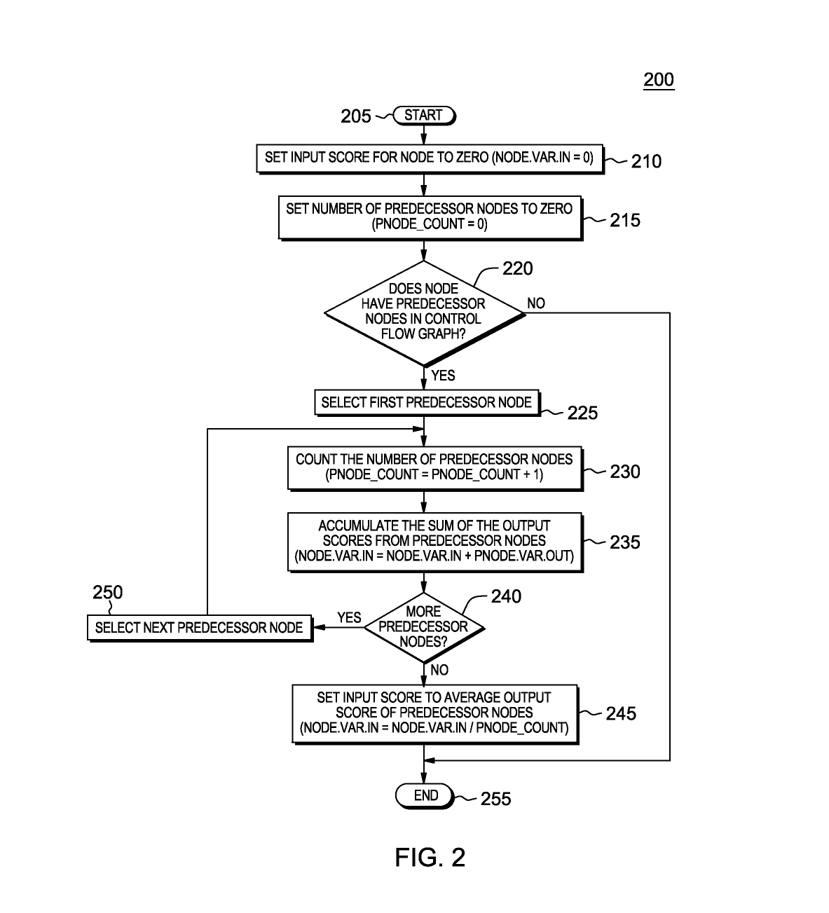

The first, or earliest, node in the control flow graph may be selected at 115, and input score processing for the node may begin. The first variable declared, modified, or referenced in the node may be selected at 120. An input score may then be determined for the variable in the selected node at 125. A variable's input score may be based on the output scores for the variable in all predecessor nodes in the control flow graph. An example embodiment for determining an input score is shown in FIG. 2, discussed below. If there are more variables declared, modified, or referenced in the selected node at 130, then the next variable in the node may be selected at 135 and an input score may then be determined for that variable at 125.

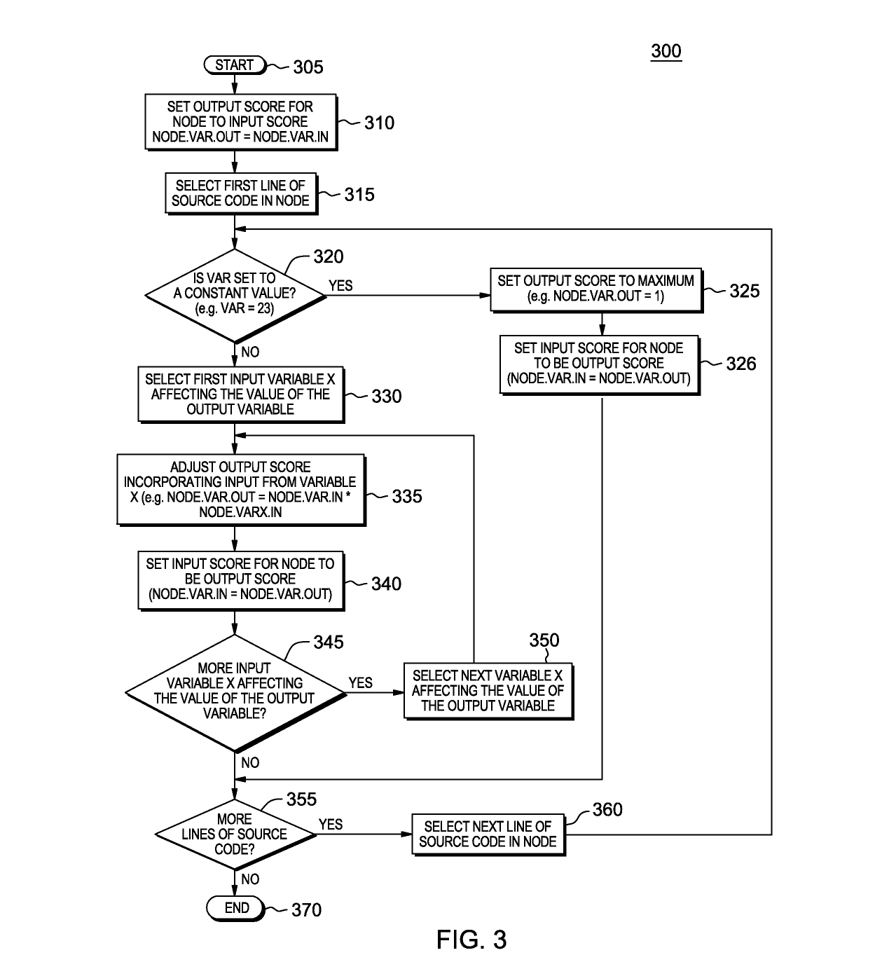

When all variables declared, modified, or referenced in the selected node have been processed at 130, then output score processing for the node may begin. The first variable declared, modified, or referenced in the node may again be selected at 140. The current output score for the variable may be saved at 145, and a new output score may be determined for the variable in the selected node at 150. A variable's output score may be based on the input scores of itself and other variables, and may also be based on how the variable is modified by the lines of source code in the selected node. An example embodiment for determining an output score is shown in FIG. 3, discussed below. If there are more variables declared, modified, or referenced in the selected node at 155, then the next variable in the node may be selected at 160, the current output score for that variable may be saved at 145, and a new output score may then be determined for that variable at 150.

When all variables declared, modified, or referenced in the selected node have been processed at 155, a score processing pass for the selected node is complete. At this point, each variable declared, modified, or referenced in the selected node may have an input score (node.var.in), a saved output score, and a new output score (node.var.out). If there are more nodes in the control flow graph at 165, then the next node may be selected at 170, and the score processing pass may begin for the next node at 120.

When all nodes in the control flow graph have been processed at 165, a score processing pass for the control flow graph is complete. The output scores (node.var.out) for all variables in all nodes are then compared to their respective saved output scores to determine if, or how much, the output scores changed during this latest score processing pass. If any output score has changed, then the first node in the control flow graph is again selected at 115 and a new score processing pass for the control flow graph is performed.

When all output scores remain equal to their respective saved output scores at 175, then these output scores are the final output scores for source code. One or more of the output scores may be displayed or otherwise presented to a user at 180, and the method ends at 185.

FIG. 2 depicts an example method 200 for determining an input score for a source code variable entering a node in a control flow graph. Method 200 produces an input score that is the average output score for the variable at all predecessor nodes in the control flow graph. Predecessor nodes are nodes in the control flow graph from which the current node is reachable. In some embodiments, a different algorithm may be used in determining the input score.

From start 205, the input score (node.var.in) is initialized to zero at 210 and the number of predecessor nodes (pnode_count) is initialized to zero at 215. If the current node has no predecessor nodes at 220, then the node is unreachable from the other nodes and the method ends at 255 with the input score remaining at zero. If the current node is reachable from other nodes at 220, then the first predecessor node is selected at 225. The pnode_count is incremented at 230, and the output score for the variable at the predecessor node is added to the input score at 235. If there are more predecessor nodes at 240, then the next predecessor node is selected at 250, pnode_count is incremented at 230, and the output score for the variable at the predecessor node is added to the input score at 235. In this manner, the output scores for the variable at all predecessor nodes are accumulated and the number of predecessor nodes is determined. When there are no more predecessor nodes at 240, the accumulated output scores are divided by the number of predecessor nodes to determine the input score at 245, and the method ends at 255.

FIG. 3 depicts an example method 300 for determining an output score for a source code variable exiting a node in a control flow graph. In some embodiments, a different algorithm with different mathematical expressions may be used in determining the output score. From start 305, the output score (node.var.out) is initialized at 310 to the input score for the variable as it enters the node. An example method for determining an input score is shown in FIG. 2.

The first line of computer source code in the node is selected at 315. Depending on whether or how the variable is affected by the selected line of source code, the output score may be replaced, adjusted, or simply maintained. If the selected line of source code sets the variable to a constant value at 320, then the output score may be set to the maximum value at 325. In some embodiments, the maximum value may be one. A maximum score at a particular line of code indicates to the user that the variable is neither uninitialized nor affected by an uninitialized variable at that line of code. Then the input score for node.var.in is updated to be the value of node.var.out at 326.

The first input variable x affecting the value of the source code variable is selected at 330 (where x is not the source code variable itself). For example, if the line of source code is var=var1+var2, then var1 and var2 are the other variables that affect the value of the source code variable. If a variable's value is affected by another variable, then the variable's output score is multiplied by the input score of the other variable at 335. For example, if the line of source code is var=var+var1, then node.var.out=node.var.in*node.var1.in. Then the input score for node.var.in is updated to be the value of node.var.out at 340. If there are more variables that affect the value of the source code at 345, then the next variable is selected at 350.

When all the nodes in the control flow graph have been processed at 345, if there are more lines of source code in the node at 355, then the next line is selected at 360 and the output value for the variable is determined for the selected line. Note that as each line in the node is processed, the output value for the variable may be replaced, such as when the variable is set to a constant, may be adjusted, such as when the variable's value depends on itself and other variables, or may be maintained, such as when the variable's value depends on itself alone or when the variable is unmodified by the line of source code. When the last line of source code in the node has been processed at 355, the method ends at 370. Note that the output score for the variable as it exits the node is the output score determined for the variable on the last line of source code in the node. However, in some embodiments, the last output score generated for the variable at each line of source code is saved for later display to the user.

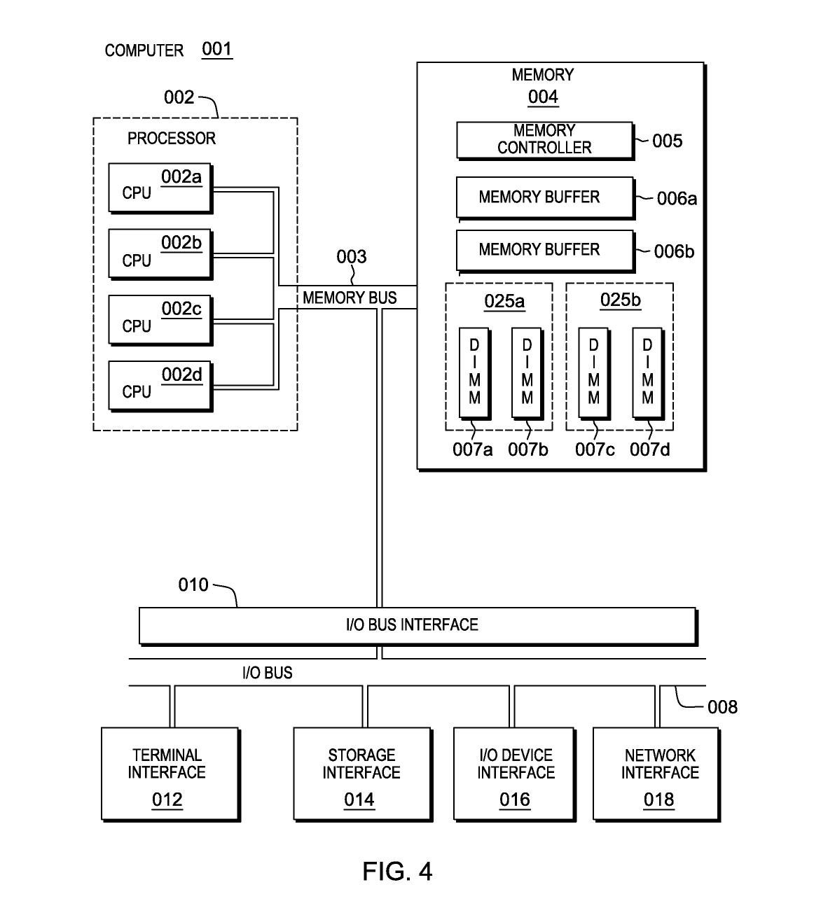

FIG. 4 depicts a high-level block diagram of an example system for implementing one or more embodiments of the invention. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffers 006 and one or more memory devices 007. In the illustrated embodiment, the memory devices 007 may be dual in-line memory modules (DIMMs), which are a series of dynamic random-access memory (DRAM) chips 015a-015n (collectively referred to as 015) mounted on a printed circuit board and designed for use in personal computers, workstations, and servers. The use of DRAMs 015 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 4 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 4 is intended to depict the representative major components of an exemplary computer system 001. But individual components may have greater complexity than represented in FIG. 4, components other than or in addition to those shown in FIG. 4 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be an intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM 0015 may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1.-7. (canceled)

8. A computer program product for evaluating usage of a variable in computer program source code, the source code represented by a plurality of nodes in a control flow graph, the computer program product comprising a computer readable storage medium having program instructions embodied therewith, the program instructions executable by a processor to perform a method comprising:
identifying, by a processor, a set of target nodes in the plurality of nodes, each target node including at least one target line of the source code, each target line defining a modification to the variable;
generating a set of first scores corresponding to the set of target nodes;
generating a set of second scores corresponding to the set of target nodes, the set of second scores based on the modifications defined by the at least one target line and further based on the set of first scores;
comparing the set of second scores to the set of first scores; and
until each second score is equal to the corresponding first score, replacing the set of first scores with the set of second scores and generating a new set of second scores.

9. The computer program product of claim 8, wherein the generating the set of second scores includes generating a line score for each target line, the line score based on the modification defined by the corresponding target line, and wherein each second score is based on the line scores generated for the corresponding target node.

10. The computer program product of claim 9, wherein the modification sets the variable to a constant value, and wherein the generating the line score based on the modification sets the line score to a maximum score.

11. The computer program product of claim 9, wherein each second score is based on an average predecessor score at the corresponding target node, the average predecessor score calculated from a subset of the set of first scores, each first score in the subset corresponding to a predecessor node of the corresponding target node in the control flow graph.

12. The computer program product of claim 11, wherein the modification sets the variable to a value of a second variable, and wherein the generating the line score based on the modification sets the line score to the average predecessor score for the second variable.

13. The computer program product of claim 11, wherein the modification sets the variable to a value based on the variable and a second variable, and wherein the generating the line score based on the modification sets the line score to the average predecessor score for the variable multiplied by the average predecessor score for the second variable.

14. The computer program product of claim 9, wherein the method further comprises:
displaying at least one of the second scores.

15. A computer system for evaluating usage of a variable in computer program source code, the source code represented by a plurality of nodes in a control flow graph, the computer system comprising:
a memory; and
a processor in communication with the memory, wherein the computer system is configured to perform a method, the method comprising:
identifying, by a processor, a set of target nodes in the plurality of nodes, each target node including at least one target line of the source code, each target line defining a modification to the variable;
generating a set of first scores corresponding to the set of target nodes;
generating a set of second scores corresponding to the set of target nodes, the set of second scores based on the modifications defined by the at least one target line and further based on the set of first scores;
comparing the set of second scores to the set of first scores; and
until each second score is equal to the corresponding first score, replacing the set of first scores with the set of second scores and generating a new set of second scores.

16. The computer system of claim 15, wherein the generating the set of second scores includes generating a line score for each target line, the line score based on the modification defined by the corresponding target line, and wherein each second score is based on the line scores generated for the corresponding target node.

17. The computer system of claim 16, wherein the modification sets the variable to a constant value, and wherein the generating the line score based on the modification sets the line score to a maximum score.

18. The computer system of claim 16, wherein each second score is based on an average predecessor score at the corresponding target node, the average predecessor score calculated from a subset of the set of first scores, each first score in the subset corresponding to a predecessor node of the corresponding target node in the control flow graph.

19. The computer system of claim 18, wherein the modification sets the variable to a value of a second variable, and wherein the generating the line score based on the modification sets the line score to the average predecessor score for the second variable.

20. The computer system of claim 15, wherein the method further comprises:
displaying at least one of the second scores.
